(19) United States
(12) Patent Application Publication
(10) Pub. No.: US 2026/0111045 A1
(43) Pub. Date: Apr. 23, 2026

(54) Fluid Control System for Supplying Pressurized Fluid to Hand Operated Pumps

(71) Applicant: ANTHONY E DAVIS, DAMASCUS, AR (US)

(72) Inventor: ANTHONY E DAVIS, DAMASCUS, AR (US)

(21) Appl. No.: 19/365,906

(22) Filed: Oct. 22, 2025

Related U.S. Application Data
(60) Provisional application No. 63/710,114, filed on Oct. 22, 2024.

(51) Int. Cl. G05D 7/01

(52) U.S. Cl. CPC G05D 7/0146

(57) ABSTRACT

A pressure reduction system for supplying fluid from a pressurized source to a hand operated pump, such as a pitcher pump or similar style manual pump, is disclosed. The system regulates the pressurized fluid from the source so that only the desired amount of fluid at substantially atmospheric pressure is supplied to the hand pump inlet when needed or called for by the pump.

### CROSS-REFERENCE TO RELATED APPLICATIONS

This application claims the benefit of co-pending U.S. Provisional Patent Application Ser. No. 63/710,114 filed 22 Oct. 2024.

### BACKGROUND OF THE INVENTION

The present invention can be utilized with a pressurized fluid source to reduce the fluid pressure and supply a constant amount of fluid to a hand pump at substantially atmospheric pressure so that the hand pump provides its designated fluid output with each pump stroke. If the pressure of the fluid from the pressurized source is not reduced to near atmospheric pressure (substantially no relative pressure) before entering the hand pump, the fluid will flow through the hand pump regardless if the hand pump is operated or not. When the fluid pressure is reduced, a sufficient quantity of fluid must be supplied to the hand pump for proper and efficient pump operation. A typical hand pump provides 12 to 30 ounces of fluid per pump stroke. If the quantity of fluid is too low, the hand pump won't receive enough fluid for each pump stroke thus reducing the pump output. In addition, cavitation may occur in the pump. If an insufficient amount of fluid is supplied to the hand pump for each stroke, the operator of the pump will soon become frustrated with the insufficient pump output and cavitation. An operator would expect that the optimal amount of fluid (for which the hand pump was designed) is expelled from the hand pump outlet with each stroke of the pump handle, regardless of the fluid source to which the pump is connected.

Hand pumps are typically used to pump water from a subterranean well. Hand pumps are also popular on children's playgrounds. Playgrounds are often located in urban areas where water is supplied from a pressurized water source, such as a municipal water supply. A typical municipal water supply provides water to designated locations in the municipality through a network of supply pipes. The water is pressurized for delivery to each location. Hand pumps are designed to extract water from wells where a stagnant or unpressurized body of water is located under the ground, typically from a few feet to a few hundred feet below the surface of the ground. As described above, hand pumps are not well suited for direct connection to a source of pressurized fluid, such as water.

On a playground with a hand pump for children to play with, to compensate for a pressurized water source and to prevent the consequences of too much pressure or too little water being supplied to the hand pump, it has been a common practice to install a holding tank underground or beneath the location of the hand pump. Water is supplied to the holding tank from the pressurized water source. A valve is installed in the holding tank so that the water level or quantity is maintained at a predetermined level or volume. The hand pump inlet pipe extends into the holding tank such that the opening is submerged in the water, in the same manner as if the inlet pipe were submerged in a subterranean well. When the hand pump is operated, the inlet pipe draws water from the holding tank. The water passes through the hand pump and is expelled at the hand pump outlet. When the volume of water in the holding tank decreases by a sufficient amount (after a significant number of hand pump handle strokes), the valve opens and allows more water to refill the holding tank. Once the water volume within the holding tank is restored to the predetermined full level or full volume, the valve closes and no additional water flows into the holding tank. The size or volume of the holding tank is selected so that a sufficient amount of water is available in the holding tank when the pump is in operation. These tanks are quite large and typically range in size from 5 to 50 gallons.

The drawback of this underground or under pump tank arrangement is that a large amount of water may sit in the holding tank for extended periods of time and become stagnant or contaminated. Even when pumping is occurring, not all of the water within the holding tank is dispelled to and through the pump. Thus if the water becomes stagnant or contaminated, some stagnant or contaminated water will remain in the holding tank indefinitely. Stagnant or contaminated water may possess health and/or safety issues for children who play with the water once it is dispelled from the hand pump outlet.

There is a need for a fluid control system for connecting hand operated pumps to a pressurized water source that does not include a large holding tank. There is a need for a system wherein the water within the system is substantially completely removed which each stroke of the hand pump. More specifically, there is a need for a fluid control system that can be connected to a pressurized water supply source and regulate the water supply so that a sufficient volume of water is supplied to a hand operated pump at atmospheric (no relative) pressure but in a sufficient quantity to supply the hand pump for full capacity operation.

### SUMMARY OF THE INVENTION

The present invention comprises a fluid control system for supplying fluid from a pressurized source to a hand operated pump, such as a pitcher pump or similar style manual fluid pump having a pump handle. The system regulates the pressurized fluid so that only the desired amount of fluid at substantially atmospheric pressure is supplied to the hand or manual fluid pump when needed or called for by the pump. A constant supply of pressurized fluid to a hand operated pump will cause the fluid to flow past the hand pump check valves and piston when the pump is not being operated by a user. A supply of minimally pressurized fluid will still cause the fluid to seep past the hand pump check valves and result in fluid flowing through the pump despite the pump not being operated by a user. An undersupply of fluid (whether pressurized or not) will result in the pump being starved for fluid and the fluid likely cavitating inside the pump instead of being pumped efficiently there through. This results in inefficient operation of the pump as only a reduced or small amount of fluid will be expelled sporadically from the hand or manual pump outlet.

The fluid control system of the present invention includes a fluid inlet, optional pressure gauge, supply tube, float valve, fluid vessel, check valve and fluid outlet. Pressurized fluid, for example water, is supplied to the control system at the inlet. The input water pressure has a range depending on the source from which the water is supplied. Typically, the fluid is water and is supplied under pressure from a municipal water source. Ideally, the inlet pressure is reduced to the range of 40 to 60 psi (pounds per square inch) by a regulating valve before entering the control system. The optional pressure gauge is attached to the system inlet so that the exact water pressure entering the control system may be determined and monitored. The water flows through the inlet connection and then through a conduit or supply tube toward the top of the vessel. The vessel top directs the water to an outlet formed in the central portion of the top and then directs the water into a float valve assembly attached to the top and located in the interior cavity of the vessel or body. The float of the float valve assembly is also located within the fluid vessel interior cavity. The float valve is affixed to a nipple attached to the underside of the vessel top. The float valve has an allowable input flow rate in the range of 40 to 100 psi. At this stated pressure level, the float valve allows the vessel to be filled with water faster than water can be expelled by the hand pump. It is important to note that the water pressure on the outlet side of the float valve (and within the vessel interior cavity) is substantially lower than the water pressure on the inlet side. In fact, the outlet pressure is substantially atmospheric pressure (or no relative pressure). It is also important to recognize that the volume of water housed within the vessel interior cavity is substantially equal to the maximum volume of water that passes through the hand pump during a full pump stroke of the hand pump handle. The volume of the vessel interior cavity is approximately twice the volume of water that passes through the hand pump during a full pump stroke.

Once the pressurized water flows through the float valve assembly, the float valve prevents the water from flowing in the opposite direction back into the vessel top and toward the water inlet. The top includes a vent, adjacent to the float valve mounting nipple so that the pressure within the interior vessel cavity, and thus the pressure of the water in the vessel is substantially the same as atmospheric pressure.

When the water level in the interior cavity drops or when the volume of water within the cavity decreases, the float drops and the float valve opens thereby allowing more water to flow into the interior cavity. Once the volume of water reaches the predetermined level or volume, the float rises and the valve closes whereby no more water is allowed to enter into the interior cavity.

An outlet is formed in the vessel near the bottom or lower most area. The outlet includes a threaded fitting. A check valve housing is attached to the outlet via the threaded fitting. Within the housing is located a check valve. The check valve has multiple functions. First it acts as a back flow preventer so that water that has already been dispensed from the control system and through its outlet cannot return through the outlet and into the vessel interior cavity again. The check valve also acts as a valve so that the predetermined volume of water is held in the interior cavity until the water is called for by the hand pump.

When the operator of the hand pump makes the first pump stroke with the pump handle, the vacuum created by the hand pump piston within the hand pump body opens the control system check valve and allows the water within the interior cavity to flow through the check valve housing and outlet connection, through the hand pump supply conduit and to the hand pump inlet. Once the volume of water in the vessel interior cavity has decreased, the float valve opens and allows pressurized water to refill the interior cavity. Due to the high pressure of the water source and the fill capacity of the float valve, the interior cavity is refilled with water very quickly. When the operator of the hand pump makes subsequent strokes with the pump handle, a sufficient quantity of water is in the system and available to be withdrawn by the hand pump.

Similarly, when the operator of the hand pump stops pumping, water is no longer called for by the hand pump as there is no longer a vacuum in the supply conduit from the fluid control system outlet connection to the hand pump inlet connection sufficient to open the control system check valve. The check valve remains closed so that no additional water is allowed to leave the vessel and no additional water is supplied to the hand pump. Any unfilled water volume in the interior cavity of the control system that is not already filled with water will be filled with water until the float valve float floats to its uppermost position and the flow of pressurized water is stopped by the elevated float of the float valve. At this point, the interior cavity has been refilled with water to its predetermined maximum water capacity or volume.

The volume of water in the cavity of the vessel when filled to the predetermined level or volume is critical to the invention. The volume of water when the cavity is filled to the predetermined level is sized to substantially match the maximum volume of water that can be passed through the hand pump during a typical full pump stroke. A typical hand pump expels 12 to 30 ounces of water each pump stroke. However the amount of water could be lower or higher depending upon the design of the pump. The volume of the vessel cavity is approximately twice the volume of water required for a full pump stroke. When the hand pump creates a vacuum and calls for water at the hand pump inlet, the volume of water within the vessel flows from the vessel interior cavity, through the check valve, through the supply conduit and into the hand pump. As water flows out of the vessel, the float of the float valve drops and the float valve opens allowing more pressurized water to flow into the vessel interior cavity. Because the water is pressurized and the float valve is designed to allow pressurized water to pass quickly and efficiently there through, the interior cavity is refilled rapidly. Once filed, the float valve closes until the water is called for again by the hand pump.

Thus the control system supplies a predetermined volume of water to the hand pump for each pump stroke. The float valve can be adjusted to fill the vessel with more or less water depending on the specific hand pump that is coupled to the system. The control system interior cavity is continuously emptied as water is supplied to the pump and then subsequently refilled with water by the open float valve. The required amount of water for a full pump stroke is supplied to the hand pump at atmospheric pressure (no relative pressure) so that the control system can supply a volume of water equal to the hand pump capacity per stroke at its outlet. At the same time, when the user or operator of the hand pump stops pumping, no water is expelled from the control system and thus no water is dispelled from the pump outlet. This is due to the overall reduction in water pressure from the pressurized water source at the control system inlet, the water being at atmospheric pressure in the vessel and at the control system outlet, and the check valve that prevents water from flowing out of the vessel.

In one embodiment a fluid control system for supplying fluid from a pressurized fluid source to a hand operated pump is provided including a vessel having a fluid cavity; the vessel having a vessel inlet and a vessel outlet formed therein; a float valve, the float valve having a float valve inlet and a float valve outlet; the pressurized fluid source coupled to the float valve inlet; the float valve positioned to regulate a flow of pressurized fluid into the fluid cavity; the float valve outlet located within the fluid cavity; a check valve coupled to the vessel outlet; the hand pump having a pump inlet, the pump inlet being coupled to the check valve; and wherein fluid at atmospheric pressure is withdrawn from the vessel through the check valve when the hand pump is operated.

In another embodiment a fluid control system for supplying fluid from a pressurized fluid source to a hand operated pump is provided including a vessel defining a fluid retaining cavity; the vessel having a vessel inlet opening and a vessel outlet opening; a float valve having a float valve inlet and a float valve outlet, the float valve inlet coupled to the pressurized fluid source and the float valve outlet positioned to allow fluid to flow into the fluid retaining cavity through the vessel inlet opening; the float valve having a float located within the fluid retaining cavity; a check valve coupled to the vessel outlet opening; the check valve having a check valve outlet connected to the hand operated pump; and wherein the fluid from said pressurized fluid source is controllably dispensed through the float valve into the fluid retaining cavity and fluid at atmospheric pressure flows out of the vessel through the check valve when the hand pump is operated.

In another embodiment a liquid control system for supplying pressurized liquid from a pressurized liquid source to a hand pump is provided including a vessel; a float valve having a float valve inlet coupled to the pressurized liquid source and a float valve outlet positioned to flow into the vessel; a liquid outlet formed in the vessel and coupled to a check valve; the check valve coupled to the hand pump; and wherein the pressurized liquid from the pressurized liquid source flows through the float valve into the vessel and liquid at atmospheric pressure flows out of the vessel and through the check valve when the hand pump is operated.

The fluid or liquid control system float valve regulates a volume of fluid or liquid within the fluid cavity. The volume of fluid or liquid can be adjusted by adjusting the float valve. The fluid or liquid control system includes a maximum volume of fluid or liquid within the fluid cavity permitted by the float valve that is substantially equal to a volume of fluid or liquid required by the hand pump for a single stroke of the hand pump.

### BRIEF DESCRIPTION OF DRAWINGS

FIG. 1 is a top perspective view of the control system;

FIG. 2 is a front elevation view;

FIG. 3 is a top exploded perspective view;

FIG. 4 is a bottom perspective view of the top plate;

FIG. 5 is a cutaway view of the control system shown in FIGS. 1 and 2;

FIG. 6 is system view showing the water supply line, control valve, pump supply line and hand-operated pump;

FIG. 7 is a cutaway view, similar to FIG. 5, of the control system filled with water;

FIG. 8 is a cutaway view, similar to FIG. 5, of the control system while the pump is in operation; and

FIG. 9 is a cutaway view, similar to FIG. 5, of the control system after pumping the pump has stopped.

FIG. 10 is a top perspective view of a second embodiment of the control system;

FIG. 11 is a top exploded perspective view of the second embodiment;

FIG. 12 a side view of the second embodiment with a portion of the vessel cut-away.

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention which is defined by the claims.

The control system 10 and 110 of the present invention is designed to control the flow of fluid, such as a liquid. Ideally, the preferred liquid utilized by the invention is water. While this specification may refer to water in the descriptions contained herein, it is to be understood that the present invention is suitable for use with any fluid or liquid.

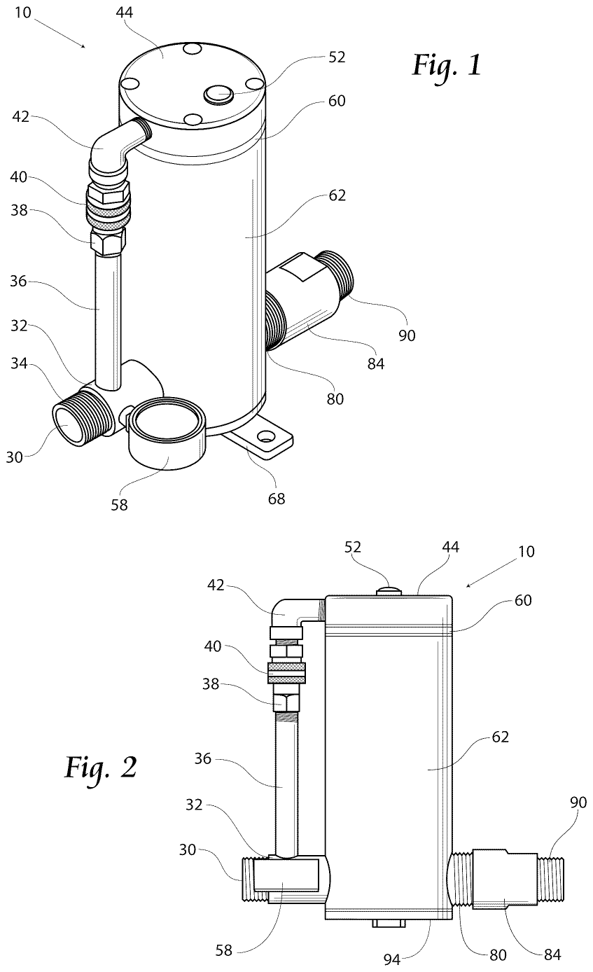

A first embodiment of the invention is shown in FIGS. 1-9. Referring to FIGS. 1, 2 and 3, control system 10 receives pressurized fluid, for example water, at a fluid inlet 30. The pressurized water flows through an inlet connection 32 having threads 34, past a pressure gauge 58, and then through an inlet nipple 36, a quick disconnected plug 38, a quick disconnect socket 40, an elbow adapter 42 and into a top plate 44. The input fluid pressure typically has range, depending upon the source of the fluid. In the case of the fluid being water, the inlet water pressure depends on the municipality from which the water is supplied. Ideally, if the pressure is too high, the pressure is reduced to the range of 40 to 60 psi (pounds per square inch) by a regulating valve (not shown) located prior to the fluid inlet 30. A pressure gauge 58 may be supplied as shown (connected to the inlet connection 32) so that the exact fluid pressure entering the control system 10 may be determined and monitored.

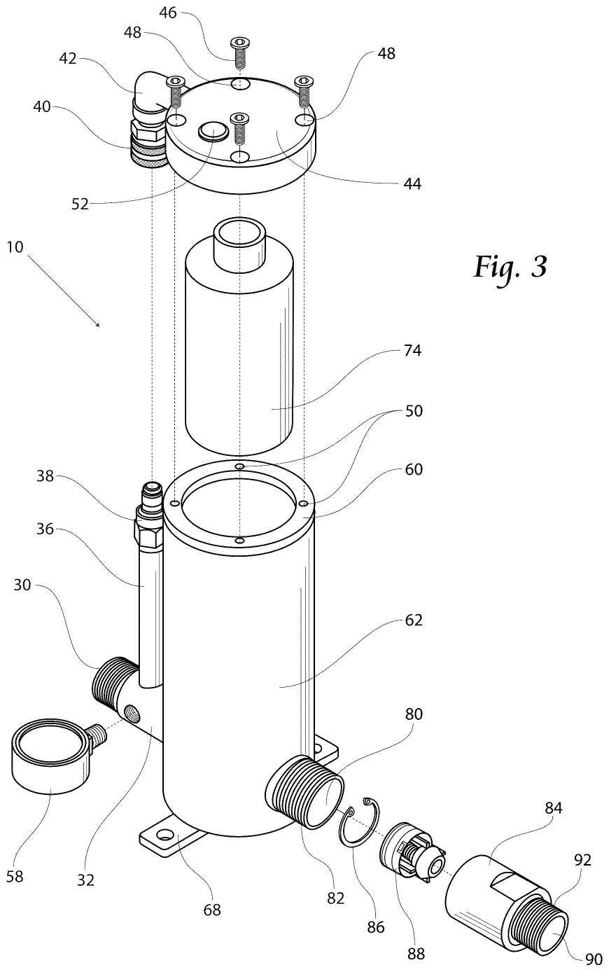

The quick disconnect plug 38 and quick disconnect socket 40 are provided so that the top plate 44 can be removed from the valve body 62 in order to access the valve body interior cavity 64. This is best shown in the exploded view of FIG. 3. A top ring or gasket 60 is provided to seal the top plate 44 to the valve body 62 when the four fasteners 46 are secured within the threaded openings 50 formed in the top of the valve vessel or body 62

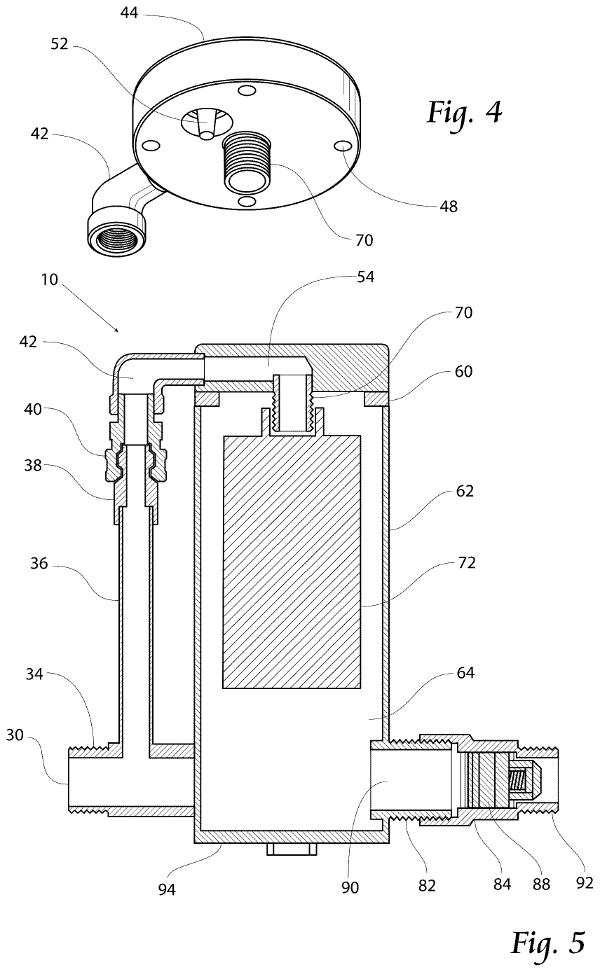

As shown in FIG. 4, the top plate 44 includes a threaded float valve nipple 70 for attachment of the float valve assembly 72 (not shown in this Figure). Top plate 44 also includes a vent plug assembly 52. Top plate 44 further includes openings 48 for the fasteners 46 that secure it to the top of the valve body 62. The multiple fasteners 46, that pass through openings 48 formed in top plate 44, are best shown in FIG. 3. The quick disconnect plug 38 and quick disconnect socket 40 are provided between the inlet nipple 36 and elbow adapter 42 so that top plate 44 can be easily removed if necessary to access the float valve assembly 72 and interior cavity 64 of the valve body 62 as previously described. It should be appreciated that the quick disconnects 38/40 are not required to practice the invention and are provided for convenience only. In this case, the inlet nipple 36 could be extended and mate directly with the elbow adapter 42.

As best seen in the cutaway view of FIG. 5, a passageway 54 formed in the top plate 44 directs the fluid flowing through the elbow adapter 42 toward the top plate center region and into a float valve assembly 72 that is threadedly affixed to a float valve nipple 70 mounted on the underside of the top plate 44. The float valve assembly 72 has an input flow rate in the range of 40 to 100 psi. At this pressure level, the float valve 72 allows the valve body 62 interior cavity 64 to be filled with fluid quickly and thus faster than fluid can be expelled by the hand pump 20 (as will be described below in detail).

Once the pressurized fluid flows through the float valve assembly 72, the valve 72 prevents the fluid from flowing in the opposite direction back into the top plate 44 and toward the fluid inlet 30. The valve body 62 top plate 44 includes a vent plug assembly 52 so that the pressure within the valve body interior cavity 64 is the same as atmospheric pressure. The vent plug assembly 52 is located adjacent to the mounting point for the float valve assembly 72.

If the interior cavity 64 is not full of fluid, the float valve 72 opens thereby allowing more fluid to flow into the cavity 64. Once full, the float 74 rises and the valve 72 closes whereby no more fluid is allowed to enter into the interior cavity 64.

A mounting tab 68 is attached to the control system body 62 near the bottom side 94. The mounting tab 68 is utilized to attach the control system 10 to a support structure (not shown).

An outlet 90 is also formed in the valve body 62 near the bottom side 94. The outlet 90 includes a nipple 80 having threads 82. A check valve housing 84 is threadedly attached to the outlet nipple 80. Within the housing 84 is located a check valve 88. The check valve 88 has multiple functions. First check valve 88 acts as a back flow preventer so that fluid that has already been dispensed from the control system 10 (and through the check valve 88) cannot return through the outlet 90 and into the interior cavity 64. The check valve 88 also acts as a fluid valve and holds the fluid in the valve body 62 until the fluid is called for by the pump 20. This occurs when an operator of the pump begins pumping the pump handle. This causes a vacuum in the pump water supply line that is sufficient to open the check valve 88. The pump water supply line 24 is connected to the outlet 90 and to the hand pump inlet. These are typically threaded connections, for example utilizing external threads 92 formed on the check valve housing 94

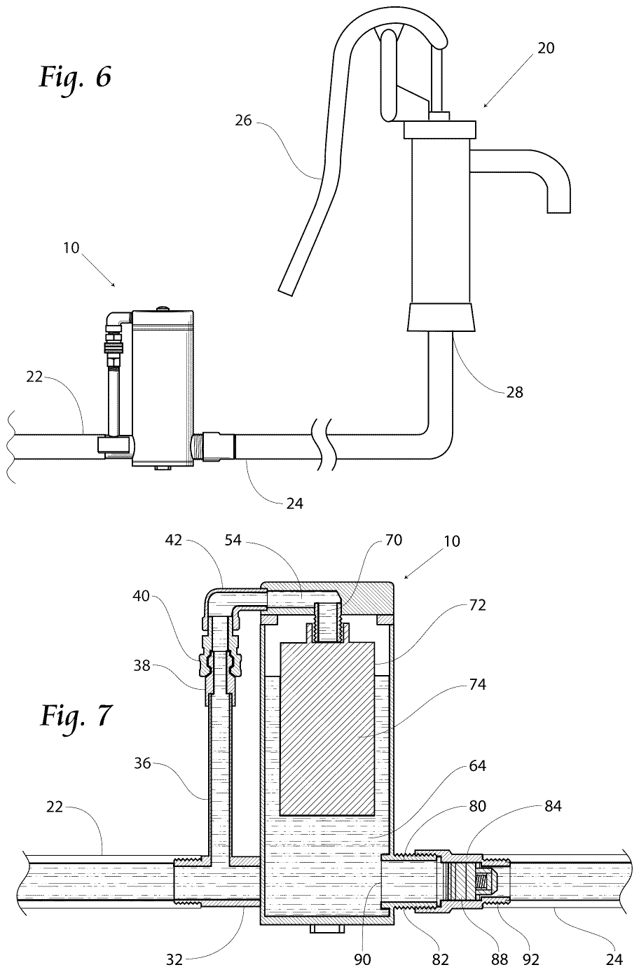

FIG. 6 depicts the entire system, including the control valve supply line 22, the control system 10, the pump supply line 24, and the hand pump 20.

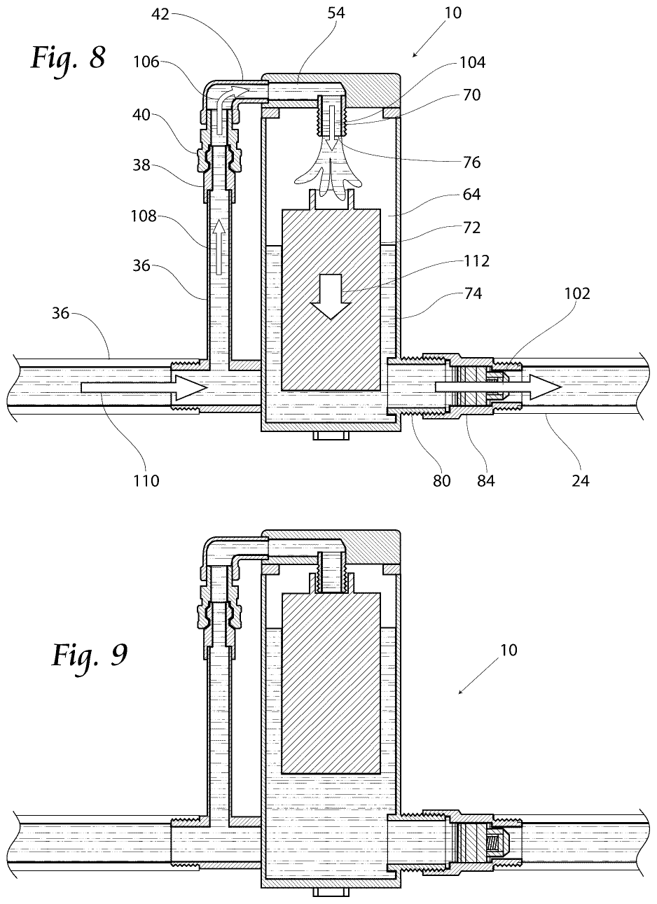

FIGS. 7-9 depict the control system 10 prior to use (FIG. 7), in use (FIG. 8) and after use (FIG. 9). FIG. 7 shows the control system 10 fully charged with fluid. For example, pressurized water resides in the supply line 22 and up to the float valve 72. The float 74 of the float valve assembly 72 is in its uppermost position and thus the float valve is closed. Therefore, no additional water is allowed to flow through the valve 72 and into the interior cavity 64. The interior cavity 64 is filled to its predetermined capacity with water. The water is at atmospheric pressure as the vent plug assembly 52 provides that no additional pressure is built up in the interior cavity 64 when it is filled with water. Check valve 88, which is also in its closed position, retains the volume of water within the interior cavity 64.

As shown in FIG. 8, when the operator of the hand pump 20 makes the first stroke with the pump handle 26 (see FIG. 6), the vacuum created by the hand pump 20 opens the check valve 88 and allows the water within the interior cavity 64 of the valve body 62 to flow through the check valve housing 84 and outlet 90 connection, and through the supply line 24 as shown by arrow 102. Once the volume of water in the vessel interior cavity 64 has decreased, the float 74 drops (as shown by arrow 112), the float valve 72 opens and allows the pressurized water to refill the interior cavity 64 as shown by arrow 104. The volume of water in the interior cavity 64 will continue to decrease as water is drawn out (arrow 102) and then increase as water flows in from the float valve 72 (arrow 104). When float valve assembly 72 is open, water flows through elbow adapter 42 (as shown by arrow 106), inlet nipple 36 (as shown by arrow 108) and inlet 30 (as shown by arrow 110).

When the operator of the hand pump 20 stops pumping the handle 26, water is no longer called for as there is no longer a vacuum in the conduit 24 from the hand pump 20 to the outlet 90 connection. The check valve 88 closes so that no additional water is supplied to the hand pump 20. Any volume in the interior cavity 64 that is not already filled with water will be filled with water until the float 74 floats to its highest position (as shown in FIG. 9) and the flow of pressurized water is stopped by the float valve 72. At this point, the interior cavity 64 is filled or recharged with water.

The volume of water in the cavity 64 when filled is critical to the invention. The volume of water in the filled cavity is sized to substantially match the maximum volume of water that can be housed in and subsequently expelled from the hand pump 20 during a typical single, full pump stroke.

When the hand pump 20 creates a vacuum and calls for water, the volume of water within the valve body cavity 64 flows from the interior cavity 64, through the check valve 88, through the supply conduit 24 and into the hand pump 20. As water flows out of the control system 10, the float 74 of the float valve 72 drops and the float valve opens allowing pressurized water to flow into the control valve interior cavity 64. Because the water is pressurized, this happens rapidly. Once filed, the float valve 72 closes until the water is called for again by the hand pump 20. If the pump operator continues to pump the pump handle 26 rapidly, the float valve will continually open and close with each stroke as the interior cavity is emptied and refilled with water.

Thus the control system 10 supplies a predetermined volume of water to the hand pump 20 for each pump stroke. The control system 10 interior cavity 64 is continuously emptied as water is supplied to the pump 20 and subsequently refilled by the open float valve 72. The required amount of water for a full pump stroke is supplied to the hand pump 20 at atmospheric pressure (no relative pressure) so that the pump 20 can supply a volume of water equal to the hand pump capacity per stroke at its outlet. At the same time, when the user or operator of the pump stops pumping, no water is expelled from the pump outlet. This is due to the reduction in water pressure from the pressurized water source connected at the control valve inlet 30 to the control valve outlet 90.

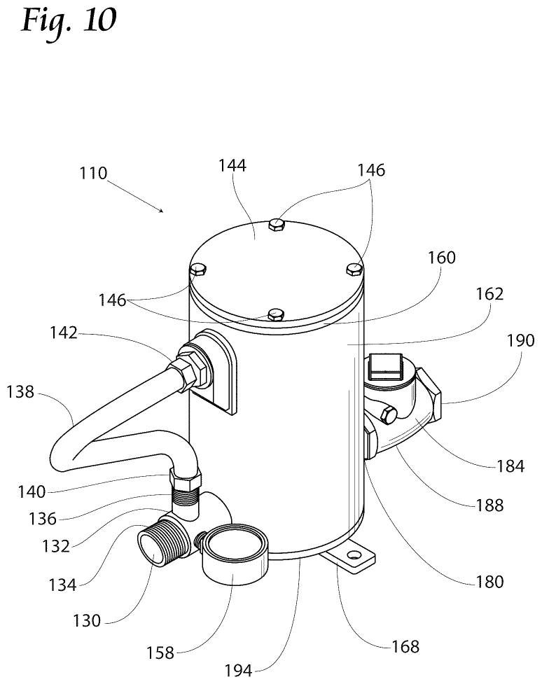

A second embodiment of the invention is shown in FIGS. 10, 11 and 12. Referring to FIGS. 10, 11 and 12, the control system 110 receives pressurized fluid, for example water, at a fluid inlet 130. The pressurized water flows through an inlet connection 132 having threads 134 and then through an inlet nipple 136. While the inlet connection 132 is affixed to vessel 162, it does not allow fluid to enter the body or vessel 162. The pressurized fluid flows into flexible hose 138. The flexible hose 138 has a first end 140 coupled to the inlet nipple 136 and a second end 142 coupled to the inlet of the float valve assembly 172. The input fluid pressure typically has range that may vary during operation, depending upon the source of the fluid. In the case of the fluid being water, the inlet water pressure depends on the municipality from which the water is supplied. Ideally, if the pressure is too high, the pressure is reduced to the range of 40 to 60 psi (pounds per square inch) by a regulating valve (not shown) located prior to the fluid inlet 130. A pressure gauge 158 may be supplied as shown (connected to the inlet connection 132) so that the exact fluid pressure entering the control system 110 may be determined and monitored.

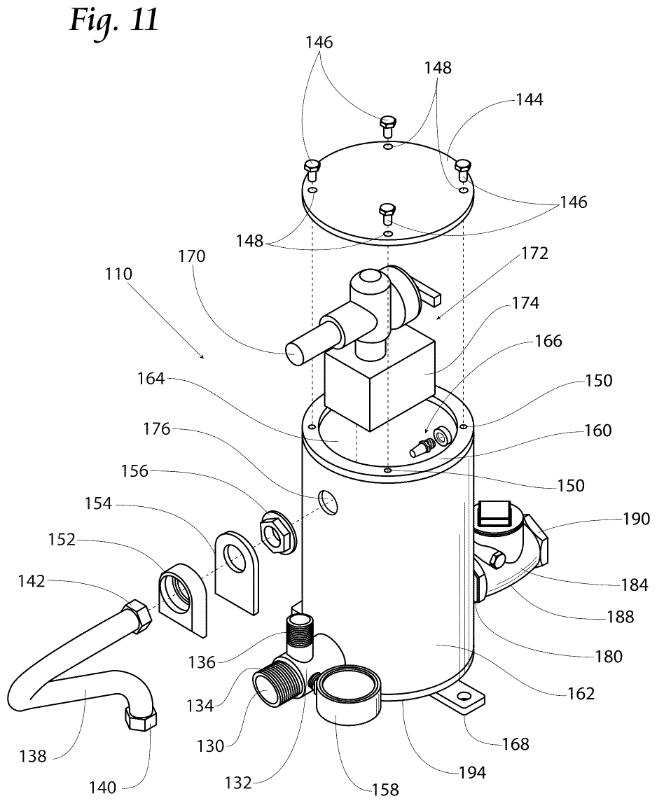

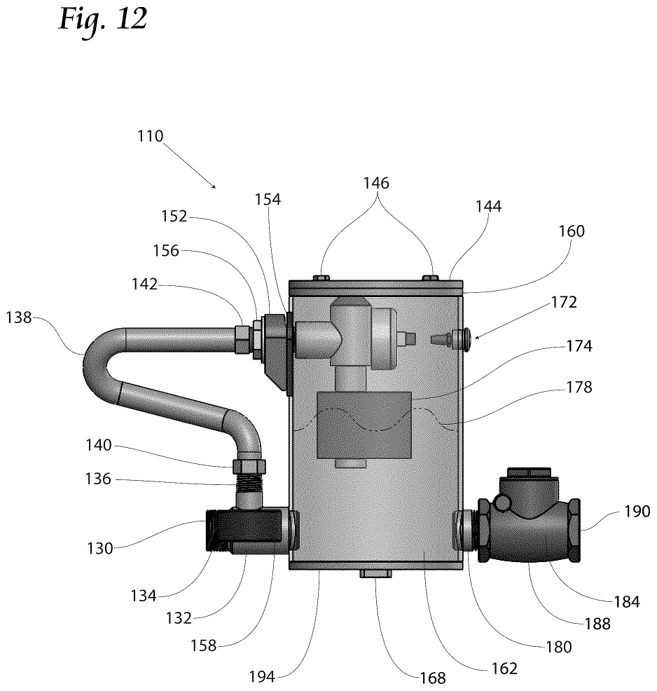

A top plate 144 is affixed to and can be removed from the valve body or vessel 162 in order to access the vessel interior cavity 164 (shown in FIGS. 11 and 12). A top ring or gasket 160 is provided to seal the top plate 144 to the valve body 162 when the four fasteners 146 are secured within the threaded openings 150 formed in the top of the valve body or vessel 162

As best seen in the views of FIGS. 11 and 12, a float valve assembly 172 includes a float valve inlet 170. Inlet 170 is coupled to flexible hose fitting 142 through the use of valve nut 156, gasket 154 and spacer 152. Inlet 170 passes through opening 176 formed in the vessel 162. The float valve assembly 172 has an input flow rate in the range of 40 to 100 psi. At this pressure level, the float valve 172 allows the vessel 162 interior cavity 164 to be filled with fluid quickly and thus faster than fluid can be expelled by the hand pump 120 (as will be described below in detail).

Once the pressurized fluid flows through the float valve assembly 172, the valve also prevents the fluid from flowing in the opposite direction back into the flexible hose 138 and toward the fluid inlet 130.

The valve body or vessel 162 includes a vent plug assembly 166 so that the pressure within the valve body interior cavity 164 is the same as atmospheric pressure. As shown in FIGS. 11 and 12, the vent plug assembly is located in the vessel 162 across from the float valve 172. Alternatively, the vent plug assembly 166 could be located in top plate 144 (similar to the first embodiment).

If the interior cavity 164 is not full of fluid to the predetermined volume set by the float valve 172, the float valve 172 opens thereby allowing more fluid to flow into the cavity 164. Once filled to the predetermined level or volume (see reference number 178 in FIG. 12), the float 174 rises and the valve 172 closes whereby no additional fluid is permitted to enter into the interior cavity 164.

A mounting tab 168 is attached to the valve body 162 near the bottom side 194. The mounting tab 168 is utilized to attach the control system 110 to a support structure (not shown).

As best shown in FIG. 12, an outlet 180 is formed in the valve body 162 near the bottom side 194. The outlet 180 includes a nipple having threads A check valve housing 184 is threadedly attached to the outlet 180. Within the housing 184 is located a check valve 188 (similar to the check valve in the first embodiment). The check valve 188 has multiple functions. First check valve 188 acts as a back flow preventer so that fluid that has already been dispensed from the vessel 162 (and through the check valve 188) cannot return through the check valve outlet 190 and into the interior cavity 164. The check valve 188 also acts as a fluid valve and holds the fluid in the valve body or vessel 162 until the fluid is called for by the pump 120. This occurs when an operator of the hand pump begins pumping the pump handle. This causes a vacuum in the pump water supply line coupled to the check valve outlet 190 that is sufficient to open the check valve 188. See generally FIG. 6.

When the operator of the hand pump makes the first stroke with the pump handle (see generally FIG. 6), the vacuum created by the hand pump opens the check valve 188 and allows the water within the interior cavity 164 of the valve body or vessel 162 to flow through the opening 180, the check valve 188 and check valve outlet 190, and then through the supply line leading to the hand pump. Once the volume of water in the vessel interior cavity 164 has decreased, the float 174 drops, the float valve 172 opens and allows pressurized water to refill the interior cavity 164. The volume of water in the interior cavity 164 will continue to decrease as water is drawn out by the hand pump and then increase as water flows in from the float valve assembly 172.

When the operator of the hand pump stops pumping the pump handle, water is no longer called for as there is no longer a vacuum in the conduit or supply line from the hand pump to the check valve outlet 190. The check valve 188 closes so that no additional water is supplied to the hand pump. Any portion of the maximum water volume in the interior cavity 164 that is not already filled with water will be filled with water until the float 174 floats to its water shut off position and the flow of pressurized water is stopped by the float valve 172. At this point, the interior cavity 164 is refilled with a predetermined amount or volume of water.

The volume of water in the cavity 164 when filled to the predetermined level or volume is critical to the invention. The predetermined volume of water in the cavity is sized to substantially match the maximum volume of water that can be housed in and subsequently expelled from the hand pump during a typical full pump stroke. A typical hand pump expels approximately 12 to 30 ounces of water per full pump stroke.

When the hand pump creates a vacuum and calls for water again, the volume of water within the valve body or vessel 162 flows from the interior cavity 164, through the check valve 188, through the supply conduit and into the hand pump. As water flows out of the control system 110, the float 174 of the float valve assembly 172 drops and the float valve opens allowing pressurized water to flow into the control valve interior cavity 164. Because the water is pressurized, this happens rapidly. Once the interior cavity 164 is refilled, the float valve assembly 172 closes until the water is called for yet again by the hand pump. If the pump operator continues to pump the pump handle rapidly, the float valve assembly will continually open and close (or remain open) with each stroke as the interior cavity is substantially emptied and refilled with water.

Thus the control system 110 supplies a predetermined volume of water to the hand pump for each pump stroke just prior to the hand pump creating the negative pressure or vacuum required to draw the water from the interior cavity 164, through the outlet 180 and check valve 188 to the hand pump. The control system 110 interior cavity 164 is continuously emptied as water is supplied to the pump and subsequently refilled by the open float valve assembly 172. The required amount of water for a full pump stroke is supplied to the hand pump at atmospheric pressure (no relative pressure) so that the hand pump can supply a volume of water equal to the hand pump volume per stroke at its pump outlet. At the same time, when the user or operator of the pump stops pumping, no water is expelled from the pump outlet. This is due to two primary factors. First, the float valve assembly 174 remains closed thus stopping the flow of pressurized water. Second, the check valve 188 prevents the water in the interior cavity 164 of the vessel 162 from leaving the vessel 162 until a sufficient vacuum is provided at the check valve 188 to open the check valve and allow water at atmospheric pressure to flow from the check valve outlet 190. Thus the control system meets the goals of preventing the flow of pressurized water to the hand pump while the pump is idle and of supplying the optimal amount of non-pressurized water to the hand pump when the hand pump is in use.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention which is defined by the claims.

1. A fluid control system for supplying fluid from a pressurized fluid source to a hand operated pump, the control system comprising:
a vessel having a fluid cavity;
said vessel having a vessel inlet and a vessel outlet formed therein;
a float valve, said float valve having a float valve inlet and a float valve outlet;
said pressurized fluid source coupled to said float valve inlet;
said float valve positioned to regulate a flow of pressurized fluid into said fluid cavity;
said float valve outlet located within said fluid cavity;
a check valve coupled to said vessel outlet;
said hand pump having a pump inlet, said pump inlet being coupled to said check valve; and
wherein fluid at atmospheric pressure is withdrawn from said vessel through said check valve when said hand pump is operated.

2. The fluid control system of claim 1 wherein the float valve regulates a volume of fluid within the fluid cavity and said volume of fluid can be adjusted.

3. The fluid control system of claim 2 wherein a maximum volume of fluid within the fluid cavity permitted by the float valve is substantially equal to a volume of fluid required by the hand pump for a single stroke of the hand pump.

4. The fluid control system of claim 1 wherein the float valve is located in said vessel;

5. The fluid control system of claim 1 wherein the fluid is water.

6. The fluid control system of claim 4 further comprising a vent formed in said vessel.

7. A fluid control system for supplying fluid from a pressurized fluid source to a hand operated pump, the fluid control system comprising:
a vessel defining a fluid retaining cavity;
said vessel having a vessel inlet opening and a vessel outlet opening;
a float valve having a float valve inlet and a float valve outlet, said float valve inlet coupled to said pressurized fluid source and said float valve outlet positioned to allow fluid to flow into said fluid retaining cavity through said vessel inlet opening;
said float valve having a float located within said fluid retaining cavity;
a check valve coupled to said vessel outlet opening;
said check valve having a check valve outlet connected to said hand operated pump; and
wherein said fluid from said pressurized fluid source is controllably dispensed through said float valve into said fluid retaining cavity and fluid at atmospheric pressure flows out of said vessel through said check valve when said hand pump is operated.

8. The fluid control system of claim 7 wherein a maximum volume of fluid within the fluid retaining cavity permitted by the float valve is substantially equal to a volume of fluid required for a stroke of said hand pump.

9. The fluid control system of claim 7 wherein the float valve regulates a volume of fluid within the fluid retaining cavity and said volume of fluid can be adjusted.

10. The fluid control system of claim 7 wherein the fluid is water.

11. The fluid control system of claim 7 wherein the float valve is located in said vessel.

12. The fluid control system of claim 11 further comprising a vent formed in said vessel.

13. A liquid control system for supplying pressurized liquid from a pressurized liquid source to a hand pump, the liquid control system comprising:
a vessel;
a float valve having a float valve inlet coupled to said pressurized liquid source and a float valve outlet positioned to flow into said vessel;
a liquid outlet formed in said vessel and coupled to a check valve;
said check valve coupled to said hand pump; and
wherein said pressurized liquid from said pressurized liquid source flows through said float valve into said vessel and liquid at atmospheric pressure flows out of said vessel and through said check valve when said hand pump is operated.

14. The liquid control system of claim 12 wherein a predetermined volume of liquid supplied by the float valve within the vessel is substantially equal to the amount of liquid required for a stroke of the hand pump.

15. The liquid control system of claim 12 wherein the float valve regulates a volume of liquid within the liquid retaining cavity and said volume of liquid can be adjusted.

16. The liquid control system of claim 12 wherein the liquid is water.

17. The liquid control system of claim 12 wherein the float valve is located in said vessel.

18. The liquid control system of claim 17 further comprising a vent formed in said vessel.
